(19) United States
(12) Patent Application Publication
(10) Pub. No.: US 2013/0332342 A1
(43) Pub. Date: Dec. 12, 2013

(54) SYSTEM AND METHOD FOR GATHERING, PROCESSING, AUTHENTICATING AND DISTRIBUTING PERSONAL INFORMATION

(71) Applicant: Sheldon Kasower, Canoga Park, CA (US)

(72) Inventor: Sheldon Kasower, Canoga Park, CA (US)

(21) Appl. No.: 13/903,524

(22) Filed: May 28, 2013

Related U.S. Application Data
(63) Continuation of application No. 11/834,662, filed on Aug. 6, 2007, now abandoned.

(51) Int. Cl. G06Q 50/26; G06Q 20/10

(52) U.S. Cl. CPC G06Q 50/265; G06Q 20/10
USPC 705/39; 705/325

(57) ABSTRACT

Various embodiments of this invention are directed towards a system and method for gathering, processing, authenticating and distributing personal information. Various embodiments of the invention disclose a system and method for gathering personal information from a plurality of sources and making the information available for entities that wish to evaluate or screen the individual. Various embodiments of the invention allow the individual to selectively grant permission to the various evaluating entities on specific background information that is stored within the system. Various embodiments allow the individual to submit information and finance the collection of information, whereby the individual can check the information for accuracy and collect commissions based on the access of the information by requesting entities.

### FIELD OF INVENTION

Various embodiments of this invention relate, generally, to systems and methods for an individual to initiate the gathering, processing, authentication and distribution, for free or resale, of his or her personal information from a plurality of sources including, but not limited to, criminal, civil, credit and medical entities. More particularly, various embodiments of this invention relate to systems and methods for an individual to authorize the release and/or resale of his or her personal information to evaluating entities including, but not limited to, other individuals, firms or government entities. In various embodiments of the invention, the system and method further acts as a toll-gate, collecting fees and distributing to the individual a substantial portion of the finances received from the sale of his or her information

### BACKGROUND

In evaluating or entering into transactions with new persons, entities often rely upon public and private sources of information including, but not limited to, credit agencies in order to evaluate a person's creditworthiness. Even in areas where an evaluating entity is not extending credit to an individual, entities often rely upon public and private factors including, but not limited to, credit reports and ratings, in making decisions concerning an individual. In hiring new employees, for example, an employer will often request a credit report or credit rating evaluation as one of the factors in evaluating a potential employee.

Credit ratings are based on a statistical analysis of a person's credit files, and represent that person's creditworthiness, which is the likelihood that the person will pay his or her bills. Because these factors are not particularly pertinent to many of the considerations in evaluating persons, evaluating entities are forced to rely upon further factors derived from public and private sources of information as well. Evaluating entities, for example, may also check police records, civil and criminal case backgrounds, personal references, medical records, prior employment references, real estate records, marital records, religious records, and further such factors.

In order to review this variety of records, evaluating entities are often required to contact a plurality of entities and review a series of documents in order to make such evaluations. Needless to say, this added time and expense is highly undesirable. An evaluating entity may even forgo or limit such a process and miss a factor that may have been important in the decision making process. Several developments have been directed towards reducing the time and expense required for the evaluation of resources.

U.S. Patent Application No. 2003/0120591 by Birkhead et al., for example, discloses one such system. Birkhead discloses a system and method for facilitating responses to credit requests received via computer and providing responses to enquiring parties over the telephone. In this manner, Birkhead's system and method is directed towards streamlining the process for obtaining credit information. Birkhead's system and method, however, is subject to many of the same shortcomings as that of traditional systems because, by only obtaining information related to creditworthiness, it fails to obtain information regarding a person's background from a plurality of reference types.

Another such system is disclosed by U.S. Patent Application No. 2005/0154664 by Guy et al. Guy's patent application discloses a credit and financial information management system that provides user authentication protocols facilitating the electronic delivery of credit reports over a computer network directly to users. The information supplied to users comprises credit history, credit ratings, other financial information, and other information related to consumer and business credit report data. Guy's system, however, falls subject to many of the shortcomings of traditional systems because it fails to supply information obtained from other important reference sources.

U.S. Patent Application No. 2002/0133365 by Grey et al. discloses a system, method, apparatus, and computer program code for aggregating reputation information. Grey's system may, for example, identify a plurality of sources having reputation information about the entity and, according to the information received, compute an aggregated reputation rating for the individual. Sources for the aggregated reputation rating may include credit bureaus, consumer agencies, government sources, commercial financial institutions, and other such sources. The information derived from these various sources is fed to a computer based algorithm that form an aggregated score based upon the information derived from the various sources.

While Grey's system improves upon prior art systems by utilizing further sources in addition to credit bureaus, the system remains undesirable because it aggregates a new score based on an internal algorithm that assigns weight to the various sources. Thus, the user of the new score is unable to assign his or her own weight to the various factors received. Some factors, such as financial information, may be relatively unimportant to a prospective employer but very important to a bank that is extending a loan. For an employer, however, factors such as criminal background information may be crucial. On the other hand, to a landlord renting an apartment, financial information and criminal background may be very important. Grey's system, however, by applying the same algorithm for all of these sources, fails to provide discrete information that is of particular use to the individual user. Thus, Grey's system also is subject to many of the same shortcomings as that of the prior art.

Therefore, there remains a long felt need in the art for a system and method for gathering, processing, authenticating and distributing personal information that provides information gathered from a variety of sources in a manner that is easily accessible and useful to a wide variety of users. There further remains a need in the art for a system and method that allows an individual to aggregate all information of a personal nature and request investigation and correction, if appropriate, of his or her personal information. Yet further, there remains a need for a system and method that allows an individual to submit information and finance the collection of information by the system and method pertaining to the individual, whereby the individual can check the information for accuracy and collect commissions based on the access of the information by requesting entities.

### SUMMARY OF THE INVENTION

Various embodiments of the invention are directed towards overcoming the above shortcomings by disclosing a system and method for aggregating personal and background information that is gathered, processed and authenticated from a variety of resource types by a trusted source. In various embodiments of the invention, the cost of aggregating and authenticating is borne by the individual, who, because of the importance of personal information in today's world, has the most vested interest in the availability and correctness of all of his or her personal information Further, because the information, if authenticated as to its source, is of great value to entities wishing to engage in some relationship with the individual, those entities pay the individual for access to some or all of the aggregated information residing at the aggregating entity

In various embodiments of the invention, the interaction with the organization employing the system and method begins with a verified individual submitting and/or authorizing his personal information to be gathered, processed, and authenticated by the organization. In various embodiments of the invention, this process can be commenced using a computer terminal and over the world-wide-web. In supplying the authorization to the organization, the individual may al so supply sources from which information may be gathered, including, but not limited to, credit bureaus, prior employers, criminal and civil litigation information, financial information, real estate information, marital status information, medical records, and other such information that may be pertinent to the individual's background.

Following the authorization by the individual and the requisite background information, the system and method operates to store, gather, and maintain information related to the individual. For certain select types of information, the information is only supplied and changed by the individual himself For other types of information, the information is gathered by the system and method once authorization has been supplied by the individual. For example, the system and method may contact one or more credit bureaus in order to access credit records and credit scores. For other types of information, the system may periodically update records related to the individual's status. For example, information related to the individual's financial status may be updated on a periodic basis. In this manner, the system operates in order to gather information from a plurality of sources in varying manners depending on the type of information gathered. Following the collection of the data set, the individual is granted access to review and approve the data set. The individual may request investigation of any records that he or she thinks is wrong. In such instances, the individual will be notified of the results at the conclusion of the investigation. If the individual disagrees with the findings of the investigation, he or she may include a personal statement that becomes part of the record.

In various embodiments of the invention, the system and method automatically updates the information database periodically at intervals chosen by the individual and/or the system and method. For example, upon receiving a background request by an evaluating entity, the system and method may update its records related to each information source.

In the manner discussed above, the system and method operates to serve as a neutral, third-party repository of diversified personal information. Because the organization is not obligated to a particular individual, it may serve as an unbiased, reliable source for obtaining the diversified personal information. Also, the organization may provide neutral third-party investigations of information sources.

In various embodiments of the invention, the system and method further operates in order to allow controlled access to an individual's information. For example, an individual may authorize access to his or her records to a specific evaluating entity. In various embodiments of the invention, the access is granted using a computer portal and over the world-wide-web. Upon authorization, the evaluating entity may access the individual's information from the organization. In various embodiments of the invention, the individual may control the extent of access allowed to various evaluating entities. For example, the individual may supply a prospective employer only access to certain pertinent records while supplying varying degrees of access to other parties. Access to certain information, such as health records, may be altogether denied to evaluating entities for which such information is irrelevant, such as prospective landlords. When access is authorized for a particular category, such as criminal records, then all information in that category becomes available to the evaluating entity.

In various embodiments of the invention, the system and method further supplies a portal for which the evaluating entity may access information pertaining to the individual. The system and method improves on the common systems known in the art by compiling information from a variety of resource types. Further, the system and method improves on the prior art systems, for example Grey's system, by presenting the data in its unaltered form. Thus, rather than recomputing an aggregate score based on information received from the various sources, the system and method serves as a single source from which the evaluating entity may conveniently access the information from a plurality of sources.

In various embodiments of the invention, the system and method receives a request from an evaluating entity to access an individual's personal records. The system and method, then, determines whether the evaluating entity is authorized to access the individual's records. If so, the evaluating entity is allowed controlled access to the specific records that the individual had allowed for that entity.

In various embodiments of the invention, the system and method enables an individual to finance the collection of information by the system and method pertaining to the individual, whereby the individual can check the information for accuracy and collect commissions based on the access of the information by requesting entities, thereby allowing the individual to recoup the cost of financing the collection of information.

In various embodiments of the invention, requests for access are received from evaluating entities over the telephone, the world-wide-web, by facsimile, by mail, or any of the various other forms known in the art for receiving such requests. In various embodiments of the invention, the system and method fulfills the information request over the world-wide-web, by facsimile, by mail, or by any of the other various means known in the art for supplying such information.

In various embodiments of the invention that supply such information over the world-wide-web, the information is supplied by presenting a web page that contains the information from various sources. In various embodiments of the invention, the web-page comprises a comprehensive report that presents the information from the various sources. In other embodiments of the invention, the information is presented as a series of HTML tabs or buttons from which the evaluating entity may select a type of information. In this manner, the system and method operates as a consolidated supply source for background information that may be accessed by evaluating entities, upon authorization of the individual.

It further remains within the contemplation of the invention to present information from a plurality of sources not specifically discussed such as general information supplied by the individual, government entities, courts, prior employers, motor vehicle records, health records, schools and universities, financial institutions, prior landlords, trade creditors, other individuals, and further such entities.

### BRIEF DESCRIPTION OF THE DRAWINGS

FIG. 1 is a flow-chart that illustrates the operation of the system and method in various embodiments of the invention.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive. Also, the reference or non-reference to a particular embodiment of the invention should not be interpreted as a limit on the scope of the invention.

In the following description, certain terminology is used to describe certain features of one or more embodiments of the invention. For instance, “evaluating entity” refers to any of the various entities that commonly seek person al background information, such as prospective employers, creditors, prospective landlords, doctors, persons of interest and other such entities; “individual” refers to any person for whom personal background information is commonly desired; “system and method” refers to any organization, business, or other such entities that practice the general principles of the invention. The following set of entities may supply personal background information: credit bureaus, financial institutions, criminal databases, sexual crime databases, civil litigation databases, county recorder databases, school and university databases, medical and heath institutions, religious institutions, prior employers, prior landlords, and individual references.

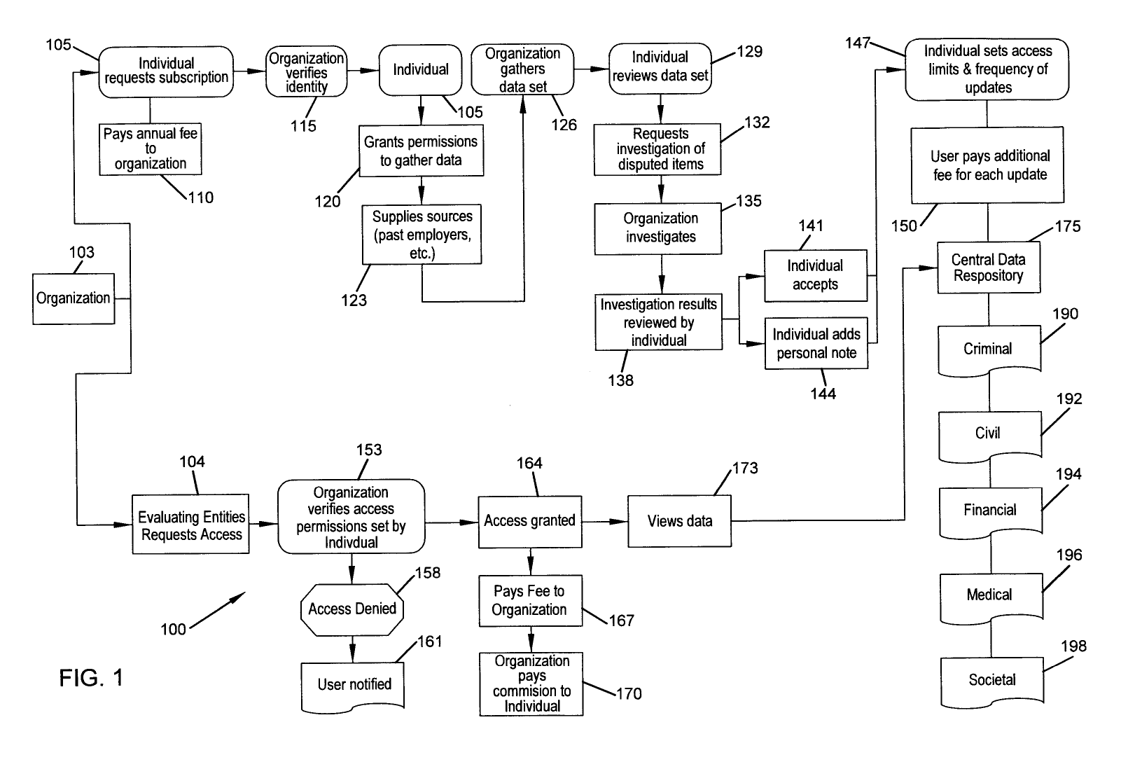

FIG. 1 is a flow-chart 100 that illustrates the operation of the system and method in various embodiments of the invention. An individual 105 initiates the transaction with the system and method by forming a subscription, which may include a fee, 110 with the organization 103, which employs the system and method. In various embodiments of the invention, the organization 103 charges a subscription fee for the subscription. Then, the organization 103 verifies the individual's identity 115. Upon verification 115, the individual 105 supplies the permission policies 120 to allow the organization 103 to collect the individual's personal background information. The individual 105 supplies sources of background information 123, including past employers, references, or other information with which the individual 105 is personally knowledgeable. The organization 103 then gathers the data set 126, which can include data sources not specifically supplied by the individual 105, and the individual 105 reviews the data set 129 to identify any potentially disputed items. If applicable, the individual 105 then requests the investigation of disputed items 132, which the organization 103 investigates 135. The results of the investigation are reviewed 138 by the individual 105. After review, the individual can choose to accept the results 141, or can choose to add a personal note 144 that explains the disputed results and that will be maintained with the data set and viewable along with the disputed item. Next, the individual 105 sets the access limits and frequency of updates 147 for the data set. The access limits include permission authentication policies which define criteria which must be satisfied for access to be granted to the individual's data set. According to the frequency of updates set by the individual, at the specified interval, the system and method will update the data set by, e.g., gathering additional data from the permitted sources supplied by the individual 105, and alternatively, from additional sources. The individual 105 pays an additional fee for each update 150. Upon the completion of the above steps, the individual's 105 compiled information is stored in a central data repository 175.

As diagrammed in FIG. 1, the information supplied to the central data repository 175 is gathered from a variety of information sources. The information sources include criminal sources 190, civil sources 192, financial sources 194, medical sources 196, and societal sources 198. In various embodiments of the invention, the criminal sources 190 may include information related to violent, sexual, or moral crimes. Civil sources 192 may include information related to marriages, lawsuits, and attachment liens. In various embodiments of the invention, the financial information 194 may include credit report information, credit score information, and asset information. In various embodiments of the invention, the medical sources 196 may include doctor reports, hospital records, and prescription records. In various embodiments of the invention, the societal sources 198 may include marital status, information from schools and universities, and religious information. In this manner, the system and method provide a central data repository 175 for varied information from a plurality of sources.

As diagrammed in FIG. 1, the information may further be selectively accessed by evaluating entities 104 requesting access. The system and method verifies 153 the individual's access permissions, and access to the individual's data set is either denied 158 or granted 164. Upon denial 158, the individual 105 is notified 161. Upon access 164, in various embodiments of the invention, the evaluating entity 104 pays a fee 167 to the organization 103. The organization then pays a commission 170 to the individual 105. Furthermore, upon granting access 164, the evaluating entity 104 views 173 the individual's data set stored and maintained in the central data repository 175.

In this manner, the system and method allows an evaluating entity 104 to selectively access a plurality of information from various information sources pertaining to the individual 105, while allowing the individual 105 control over the accuracy and the updating of the stored data set, as well as the access to his or her information. Furthermore, the system and method al lows the individual 105 to receive a commission 170 from evaluating entities 104 accessing his or her information, which can offset the cost of financing the collection and maintenance of the information, and also allow the user to benefit financially from reselling the information via the organization 103.

1. (canceled)

2. A method for gathering, processing, authenticating, and distributing an individual's personal background information, comprising:
receiving, by a personal background information computer, a subscription request from an individual to have the individual's personal background information stored into the personal background information computer;
verifying an identity of the individual;
gathering, by the personal background information computer, personal background information related to the individual from two or more sources of personal background information, the personal background information including a plurality of items;
providing a user interface to the individual allowing the individual to review the personal background information to identify any disputed items, the user interface:
including controls allowing the individual to request investigation of disputed items,
displaying results of any requested investigation, and
including controls allowing the individual to provide a personal statement associated with any disputed items; and
receiving from the individual selection of access permissions to grant to one or more non-subscribing evaluating entities, the access permissions indicating a first portion of the personal background information to be accessible by a first non-subscribing evaluating entity, and a second portion of the personal background information to be accessible by a second non-subscribing evaluating entity, wherein the first portion includes at least one item of the personal background information not included in the second portion.

3. The method of claim 2, further comprising:
receiving, by the personal background information computer, an access request from the first and second non-subscribing evaluating entities and verifying that the individual has granted access permission to the first and second non-subscribing evaluating entities;
providing access to the first and second non-subscribing evaluating entities to the first and second selected portions, respectively, of the individual's personal background information;
presenting, by the personal background information database computer, the first and second selected portions of the personal background information related to the individual to the first and second non-subscribing evaluating entities, respectively;
charging a fee to each of the first and second non-subscribing evaluating entities, with a portion of the fee paid to the individual.

4. The method of claim 2, wherein said two or more sources of personal background information comprise two or more of: credit bureaus, financial institutions, criminal databases, sexual crime databases, civil litigation databases, county recorder databases, school and university databases, medical and health institutions, religious institutions, prior employers, prior landlords, and individual references.

5. The method of claim 2 further comprising: charging a subscription fee to the individual.

6. The method of claim 2 further comprising: periodically updating said personal background information.

7. The method of claim 6, wherein the personal background information database computer further allows the individual to select intervals at which the personal background information is periodically updated.

8. The method of claim 6, wherein the personal background information is updated at each request from the one or more non-subscribing evaluating entities.

9. The method of claim 6 further comprising: charging an update fee to the individual for each of the periodic updates.

10. A computing system for gathering, processing, authenticating, and distributing an individual's personal background information comprising:
one or more computer processors configured to execute instructions in order to cause the computing system to:
receive a subscription request from an individual to have the individual's personal background information stored by the computing system;
verify an identity of the individual;
gather personal background information related to the individual from two or more sources of personal background information, the personal background information including a plurality of items;
provide a user interface to the individual allowing the individual to review the personal background information to identify any of the plurality of items that the individual disputes, the user interface:
including controls allowing the individual to request investigation of disputed items,
displaying results of any requested investigation, and
including controls allowing the individual to provide a personal statement associated with any disputed items;
receive, from the individual, selection of access permissions to grant to one or more non-subscribing evaluating entities, the access permissions indicating a first portion of the personal background information to be accessible by a first non-subscribing evaluating entity, and a second portion of the personal background information to be accessible by a second non-subscribing evaluating entity, wherein the first portion includes at least one item of the personal background information not included in the second portion.

11. The computing system of claim 10, wherein the instructions are further configured to cause the computing system to:
receive an access request from the first non-subscribing evaluating entity;
provide access to only the first portion of the personal background information to the first non-subscribing evaluating entity;
receive an access request from the second non-subscribing evaluating entity;
provide access to only the second portion of the personal background information to the second non-subscribing evaluating entity;
charging a fee to each of the first and second non-subscribing evaluating entities.

12. The computing system of claim 10, wherein the instructions are further configured to cause the computing system to determine a portion of the fee paid by the first and/or second non-subscribing evaluating entities for payment to the individual.

13. The computing system of claim 10, wherein the first and second non-subscribing evaluating entities request access to the individual's personal background information over one or more of the following mediums: telephone, facsimile, mail, or world-wide-web.

14. The computing system of claim 10, wherein the instructions are further configured to cause the computing system to periodically update said personal background information with information from additional sources.

15. A computing system comprising:
one or more computer processors configured to execute instructions in order to cause the computing system to:
gather a plurality of personal background information items related to an individual from two or more sources of personal background information;
transmit a user interface to the individual, the user interface:
listing the gathered personal background information items;
including controls allowing the individual to request investigation of respective personal background information items that the individual disputes;
displaying results of investigation regarding any personal background information items for which investigation was previously requested; and
including controls allowing the individual to provide personal statements associated with respective personal background information items.
